(19) United States
(12) Patent Application Publication
(10) Pub. No.: US 2002/0102958 A1
(43) Pub. Date: Aug. 1, 2002

(54) Sub-harmonically pumped k-band mixer utilizing a conventional ku-band mixer IC

(76) Inventor: Kenneth V. Buer, Gilbert, AZ (US)

Correspondence Address: Patrick L. Mixon, Snell & Wilmer, L.L.P., One Arizona Center, 400 E. Van Buren, Phoenix, AZ, 85004-2202, US

(21) Appl. No.: 09/771,762

(22) Filed: Jan. 29, 2001

(51) Int. Cl. H04B 15/00

(52) U.S. Cl. 455/296; 455/313

(57) ABSTRACT

A k-band frequency mixer for use with a low noise block downconverter is provided. The mixer utilizes a ku-band integrated circuit topology in a sub-harmonically pumped arrangement to downconvert a k-band radio frequency (RF) to an intermediate frequency (IF). In particular, an RF of from about 17 GHz to about 21 GHz is combined with a local oscillator frequency of about 9.75 GHz to about 11.3 GHz and then fed into an integrated circuit with an anti-parallel diode pair to produce an intermediate frequency (IF) of from about 950 MHz to about 2.15 GHz. Due to the accessibility of the integrated chip design used in this invention, mixers for use in the k-band frequency range may be wider distributed and are made more readily available and at a lower cost.

### BACKGROUND OF THE INVENTION

1. Field of the Invention

The present invention relates generally to a receiver for receiving broadcast signals. In particular, the invention relates to a low noise block downconverter for receiving k-band signals, and more particularly, to a sub-harmonically pumped k-band mixer for use in a low noise block downconverter.

2. Background of the Invention

Conventional wireless communication methods generally utilize high frequency radio waves to carry electronic information through space. Typically, the information is encoded in a radio frequency (RF) signal and then transmitted from a high frequency transmitter at a first location to a frequency receiver at a second location. Due to the distance of the transmission and the various signal interferences between the transmitter and the receiver, the RF signal received at the second location is usually very faint. Therefore, in order to process the electronic transmission, the signal is first amplified and an oscillating signal is impressed upon the amplified transmission to produce a higher frequency modulated carrier signal. The modulated carrier signal is then further processed to recover the information originally communicated in the high frequency RF signal.

Before the information in the high frequency RF signal can be read, the information must first be extracted, or demodulated, from the higher frequency modulated carrier signal. However, conventional signal processing technology is limited by its processing speed and cannot easily demodulate the high frequency RF signal from the higher frequency modulated carrier signal directly. Before demodulation can take place, the higher frequency modulated carrier signal must be downconverted to an intermediate frequency (IF), where a conventional demodulator can then extract the electronically transmitted information. Typically, the down conversion of the higher frequency modulated carrier signal is accomplished using a conventional low noise block downconverter.

The use of low noise block downconverters (LNB) to downconvert higher frequency modulated carrier signals is well known. Typical examples of LNB usage include a variety of electronic systems designed to receive communication signals, such as, Very Small Aperture Satellite Terminals (VSAT), portable satellite telephone communications terminals, point-to-point terrestrial digital radio data links, point-to-multi-point television and data broadcast transmission systems, Direct Home Satellite Television Broadcast Systems (DBS), and wireless internet data delivery.

Typically, LNBs are suitably designed to operate around a specific frequency or within a specific frequency range. For radio waves in the k-band frequency range (about 18 GHz to 27 GHz), conventional LNBs commonly include a large number of off-chip discrete components for radio frequency signal processing. The use of off-chip discrete components often introduces undesirable circuit parasitics and other unknowns which are minimally repeatable or predictable. In order to reduce or eliminate the unwanted parasitics, additional compensating electrical circuitry must be incorporated into the LNB design; the addition of which ultimately increases the cost of designing k-band LNBs where off-chip discrete components are used.

One method for reducing the number of off-chip discrete components in the k-band LNB employs GaAs MIMICs. With the rapid development of GaAs MIMIC technology, commercial GaAs MIMIC frequency downconverters have become increasingly popular for k-band LNB applications. In part, this is because GaAs MIMICs provide improved reliability, and are producible in small size and at low weight. In addition, the use of GaAs MIMICs increases broadband performance, circuit design flexibility and multifunctional performance on a single chip.

Today, several companies are offering competitive LNB devices using GaAs MIMIC technology. However, because GaAs MIMICs are generally specially designed for use in a particular application, GaAs MIMIC based LNB devices with wide applicability in the k-band range are not readily producible or widely distributed. To remain competitive as the demand for more diversified satellite services continues to grow (e.g., wireless internet technologies), companies are faced with finding ways to increase availability and applicability of LNBs in the k-band range while simultaneously reducing the cost of producing the same.

### BRIEF DESCRIPTION OF THE DRAWINGS

The exemplary embodiments of the present invention are described in conjunction with the appended drawing figures in which like numerals denote like elements, and in which:

FIG. 1 depicts a schematic block diagram of a traditional low noise block downconverter;

FIG. 2 depicts a conventional ku-band mixer; and

FIG. 3 depicts a k-band mixer in accordance with one embodiment of the present invention.

### DETAILED DESCRIPTION OF EXEMPLARY EMBODIMENTS

The invention relates to an improved receiver for receiving signals in the k-band frequency range. In particular, the invention relates to a k-band LNB which eliminates the need to design the k-band mixer using off-chip discrete components and/or GaAs MIMICs. Although the LNB and mixer disclosed herein are conveniently described with reference to its use in applications involving the k-band frequency, the invention is not to be so limited. That is, it should be appreciated by those skilled in the art that the invention may have use in various other frequency ranges or applications. For example, the invention may be useful in systems including a downconverter of high frequency radio waves to a frequency suitable for use by any frequency decoder, demodulator, or receiver, where frequency suitability is determined by the requirements of the receiving system. In addition, the LNB and mixer described herein may have particular use in the frequency range from about 3 GHz to about 30 GHz.

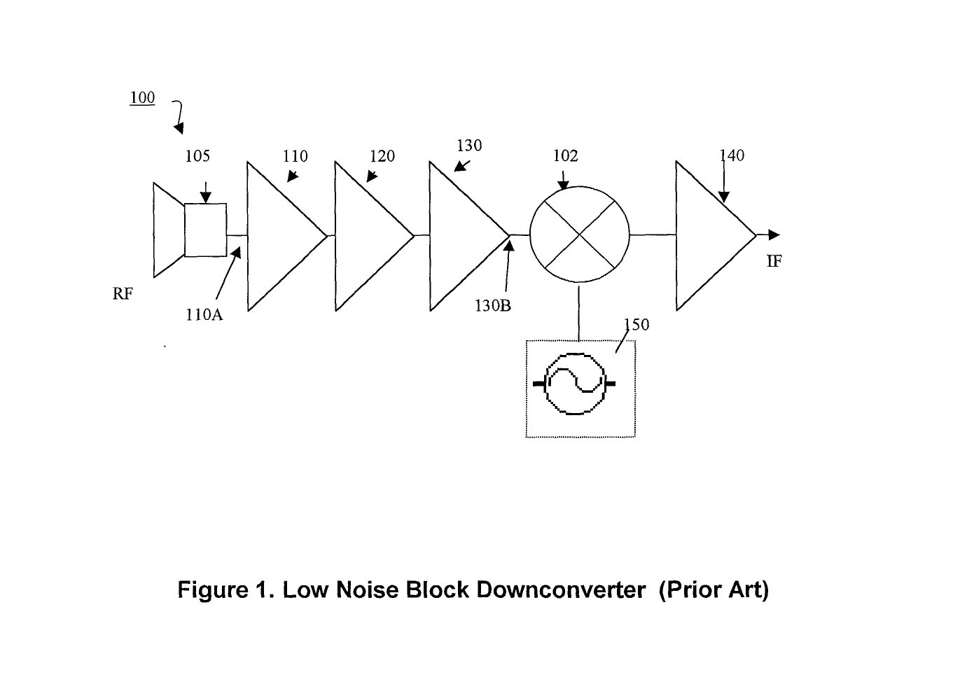

The present invention will now be described with reference to the attached drawings. Beginning with FIG. 1, a schematic block diagram of a typical low-noise block downconverter (LNB) system 100 is illustrated. As depicted, the LNB downconverter includes an antenna 105, low noise amplifiers (LNA) 110, 120, 130, a frequency mixer 102, an oscillator 150 and an IF amplifier 140.

As shown in FIG. 1, the antenna 105 is electrically connected to cascading amplifiers 110, 120, and 130. Amplifier 130 is further connected to frequency mixer 102 which is additionally electrically connected to frequency oscillator 150, and to IF amplifier 140.

The components of LNB system 100 of FIG. 1 may be of any conventional type typically used in low noise block downconverters. For example, antenna 105 may be of any type configured to receive high frequency radio waves, LNAs 110, 120, 130 and IF amplifier 140 may be any conventional amplifier capable of amplifying a signal at the appropriate frequency band, the oscillator 150 may be of any conventional oscillator for providing a local oscillating (LO) signal, and mixer 102 may be any mixer configured to mix at least two high frequency signals.

In operation, amplifier 110 is coupled to a high frequency RF signal (e.g., 12 GHz or 22 GHz) from a feedhorn (not shown) mounted at the focal point of the antenna 105. The amplifier 110 receives the high frequency RF signal at input 110A where the RF signal at input 110A is amplified by cascading amplifiers 110, 120, and 130. The amplified RF signal at output 130B of amplifier 130 is then mixed at frequency mixer 102 with an oscillating signal from external and independent oscillator 150. The mixed IF signal is then amplified by IF amplifier 140 to provide a suitable amplified IF signal for coupling to, for example, a receiver/demodulator (not shown).

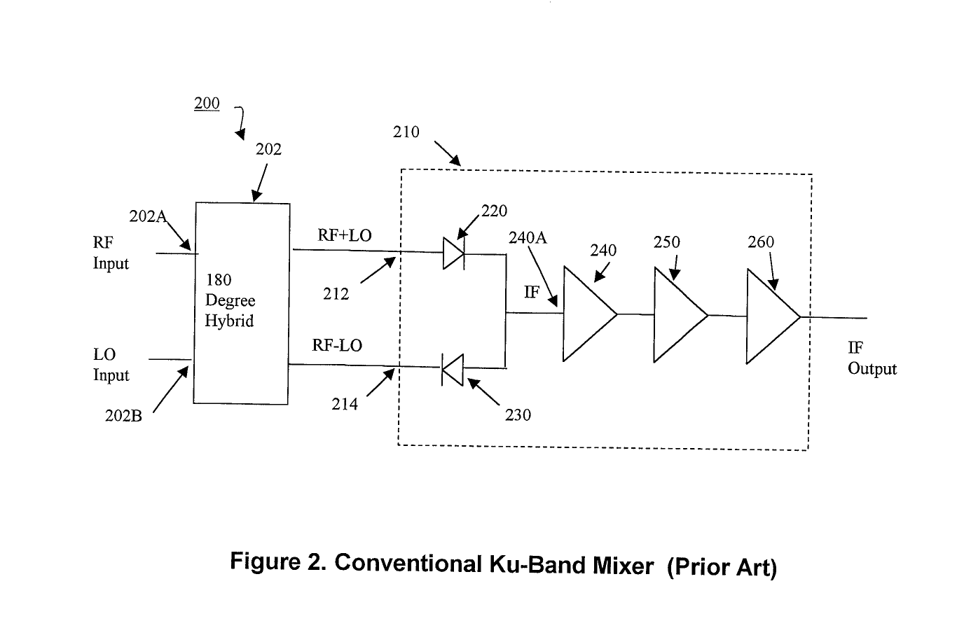

The design of conventional mixers, such as mixer 102 depicted in FIG. 1, for use in low noise block downconverters is well known. By way of example, FIG. 2 illustrates a typical mixer system 200 including an integrated circuit 210 for use in the ku-band range (from about 12-18 GHz). The IC 210 of FIG. 2 further includes a pair of matched diodes 220 and 230, and a series of cascading amplifiers 240, 250, and 260. As shown in FIG. 2, integrated circuit (IC) 210 is electrically connected to the 180 degree hybrid 202 through matched diode pair 220 and 230. In addition, matched diode pair 220 and 230 are electrically connected to cascading amplifiers 240, 250 and 260.

In accordance with the illustrated mixer system 200 of FIG. 2, the 180 degree hybrid 202 is of the type well known in the art for combining at least two frequency inputs to produce a sum and a difference in relation to the input frequencies. Accordingly, the hybrid 202 will be discussed in terms of its output signals. That is, the hybrid 202 produces a sum and a difference of the RF and LO signals depicted in FIG. 2 as (RF+LO) and (RF−LO) respectively.

The cascading amplifiers 240, 250, and 260 may be any conventional amplifiers capable of amplifying a high frequency radio wave. One skilled in the art will appreciate that the amplifiers depicted in FIG. 2 are not limited by any particular conventional construction. That is, the amplifiers may be of any conventional construction wherein the output signal is an amplification of the input signal.

Further, the construction and operation of a matched diode pair is well known in the art. Consequently, as matched diode pair 220 and 230 may be of any conventional construction, the pair will not be discussed herein in detail.

Moreover, one skilled in the art will recognize that the IC 210 is not limited by any particular diode construction. That is, one skilled in the art will recognize that other square-law devices, such as, appropriately biased FETs or bipolar transistors may be used. Further, the matched diode pair 220 and 230 may include a variety of the well known circuit configurations where the output signal represents a half-rectification of the input signal.

Further still, IC 210 may be any typical construction where representations of the components described therein are included. More particularly, IC 210 may be any conventional construction for receiving at least one RF signal in the ku-range and at least one LO signal in the ku-band range and outputting and IF signal of from about 900 MHz to about 2,500 MHz. By example, a chip which may be used with this mixer arrangement is the FMM5107VD Integrated Circuit produced by FUJITSU®.

In addition, it will be understood by those skilled in the art that IC 210 may be any typical downconverter, where a high frequency input is downconverted to an intermediate frequency. It can be further appreciated that while IC 210 is described herein as containing cascading amplifiers 240, 250, and 260 for amplifying the intermediate frequency, the amplification of the intermediate frequency can be accomplished by a single amplifier. Moreover, One skilled in the art will appreciate that the amplification of the intermediate frequency can be accomplished off-chip.

As is commonly known in the prior art, the ku-mixer depicted in FIG. 2 is typically used in a LNB arrangement substantially similar to that depicted by LNB system 100 of FIG. 1. Thus, as can be seen, the mixer system 200 of FIG. 2 represents mixer 102 of FIG. 1.

During operation, the RF and LO signals are supplied to mixer system 200, such that, the RF signal is input into the hybrid 202 at hybrid input 202A and the LO signal is input into the hybrid 202 at hybrid input 202B. The respective sum and difference signals produced by hybrid 202 are then input into the IC chip 210 at IC input nodes 212 and 214 such that the sum of the input frequencies (RF+LO) is input into node 212 and the difference of the input frequencies (RF−LO) is input into node 214.

As noted, the operation of matched diode pair is well known in the art. In particular, the matched diode pair operate to produce a half-rectification of the signal input into the pair. With particular reference to FIG. 2, matched diode pair 220 and 230 produce an intermediate frequency IF, which is a half-rectification of the (RF+LO) and (RF−LO) signals. The IF is then amplified by cascading amplifiers 240, 250, and 260 to a suitable frequency range, where the suitability of the frequency is predetermined by the requirements of the receiving system.

For mixer systems used in the ku-band range, the RF signal input is from about 10.7 GHz to about 12.75 GHz, and the LO signal input is from about 9.75 GHz to about 11.3 GHz. The matched diode pair 220 and 230 produce a half-rectified intermediate frequency (IF) in the range of about 950 MHz to about 2.15 GHz, which is then amplified in turn by cascading amplifiers 240, 250 and 260.

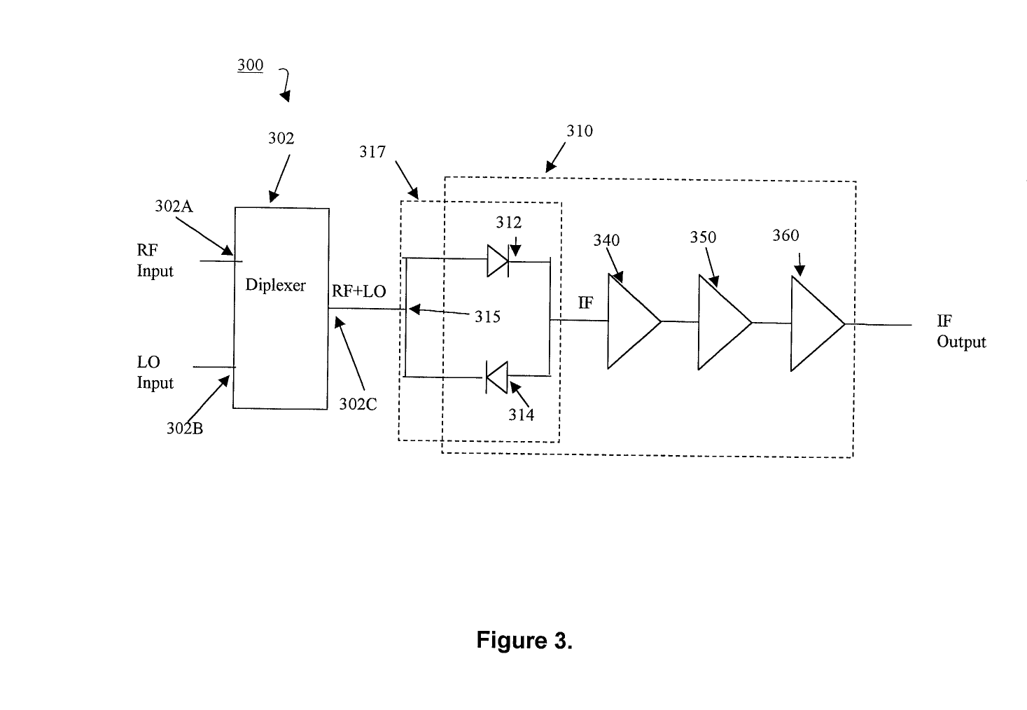

Turning now to FIG. 3, a mixer system 300 in accordance with the invention is illustrated. Mixer system 300 is particularly useful in a LNB downconverter. That is, mixer system 300 may be of particular use as a sub-harmonically pumped mixer in the k-band frequency range.

As shown in FIG. 3, the mixer system 300 includes a diplexer 302 and an IC chip 310 where IC chip 310 may be of substantially similar configuration and function as IC chip 210 described in FIG. 2. Similar to IC chip 210 of FIG. 2, IC chip 310 of FIG. 3 further includes two matched diodes 312 and 314, and cascading amplifiers 340, 350, and 360.

One skilled in the art will appreciate that the cascading amplifiers 340, 350, and 360 may be any conventional construction useful for amplifying frequency signals. Thus, amplifiers 340, 350, and 360 are not limited by any particular amplifier construction.

Further, one of ordinary skill in the art will recognize that diplexer 300 may be any configuration useful for combining at least two input signals and producing an output signal representing the sum of the input signals. For example, a suitable diplexer for this application may be comprised of a resistive combiner, lumped element combiner, or a distributed or other broad-band RF summing junction, with or without frequency selectivity on the individual RF port 302A and LO port 302B.

The matched diodes 312 and 314 are in an anti-parallel diode pair configuration 317, such that the input of anti-parallel diode configuration 317 is node 315. The operation of the anti-parallel diode pair is well known in the art, and accordingly will not be discussed herein in detail. Moreover, one skilled in the art will recognize the output of an anti-parallel diode pair is the half-rectification of the input frequency. As such, the anti-parallel diode pair 317 illustrated in this invention may be of any configuration wherein a frequency signal may be half-rectified in accordance with this invention. Further, one skilled in the art will recognize that other square law devices, such as FETs or bipolar transistors may be used in a the anti-parallel diode arrangement where the transistors may be used in a sub-harmonically pumped mixer configuration.

Further, IC chip 310 may be any typical construction where representations of the components described herein are included. As noted, IC chip 310 may be substantially similar in configuration and function to IC chip 210 of FIG. 2. More particularly, IC chip 310 may be any conventional construction for receiving at least one RF signal in the ku-range and at least one LO signal in the ku-band range and outputting IF signal from about 950 MHz to about 2,150 MHz. As with IC chip 210 of FIG. 2, the FMM5107VD Integrated Circuit produced by FUJITSU® may be used with mixer system 300 of FIG. 3.

In addition, it will be understood by those skilled in the art that IC chip 310 may be any typical downconverter, where a high frequency input is downconverted to an intermediate frequency. It can be further appreciated that while IC chip 310 is described herein as containing cascading amplifiers 340, 350, and 360 for amplifying the intermediate frequency, the amplification of the intermediate frequency can be accomplished by a single amplifier. Moreover, one skilled in the art will appreciate that the amplification of the intermediate frequency can be accomplished off-chip.

Continuing with FIG. 3, diplexer 302 is electrically connected to IC chip 310 at node 315, which is additionally connected to anti-parallel diode pair 317. Anti-parallel diode pair 317 is further connected to cascading amplifiers 340, 350, and 360.

During operation, a local oscillator (LO) signal from about 9.75 GHz to about 11.3 GHz is provided to diplexer 302 at diplexer input 302B and, a RF signal from about 17 GHz to about 21 GHz is provided to diplexer 302 at diplexer input 302A. The diplexer 302 sums the RF and LO signals to produce a combined signal denoted in FIG. 3 by (RF+LO), which is then input into the anti-parallel diode pair 317 at node 315. In this way, the resulting configuration places mixer system 300 in a sub-harmonically pumped mixer arrangement.

In accordance with the invention, IC chip 310 may have particular use with frequencies within the ku-band range. Therefore, IC chip 310 may be tuned to provide a proper on-chip diode termination from about 9.75 GHz to 11.3 GHz LO frequency, such that the LO frequency efficiently provides sub-harmonic LO switching of the anti-parallel diode pair 317. Moreover, in further accordance with this invention, the IF output from IC chip 310 is in the ku-band range from about 950 MHz to about 2.15 GHz, where the RF input into mixer system 300 is in the k-band range from about 17.0 GHz to about 21 GHz. Consequently, the IF output from the k-band mixer of the invention is within an intermediate frequency range similar to the IF frequency range of the ku-band mixer of FIG. 2, without the advent of off-chip discrete component or GaAs MIMICs.

As noted previously, the present invention may be practiced using the FMM5107VD IC chip produced by Fujitsu®, or any other similar readily producible IC ship. As a result, since FMM5107VD IC chip is readily available and producible, the present invention has a greater applicability and availability than conventional k-band mixers and may be more readily distributed in consumer products at a lesser cost than conventional k-band mixers.

It should be appreciated that the particular implementations shown and described herein are illustrative of various embodiments of the invention including its best mode, and are not intended to limit the scope of the present invention in any way. Indeed, for the sake of brevity, conventional techniques well known in the art such as the general operation of low noise block downconverters, 180 degree hybrids, diplexers, matched diode pair, anti-parallel diode pair and operational amplifiers may not be described in detail herein. Further, the connecting lines shown in the various figures contained herein are intended to represent exemplary functional relationships and/or physical couplings between the various elements. Furthermore it should be appreciated that many alternative or additional functional relationships or physical connections which may be present in a practical LNB downconverter, while not illustrated, are included in this application.

The present invention has been described above with reference to exemplary embodiments. However, those skilled in the art will recognize that changes and modifications may be made to the embodiments without departing from the scope of the present invention. For example, various types of integrated circuits designed for use in mixers in the ku-band range which are capable of implementation in a sub-harmonically pumped arrangement may be utilized, aside from the one depicted in the exemplary embodiment described herein. In addition, while the invention is described with respect to the use of a diplexer, the high frequency signals input into the mixer can be summed by any circuit element capable of producing an output equal to the sum of the input signals. These and other changes or modifications are intended to be included within the scope of the present invention, as expressed in the following claims.

What is claimed is:

1. A low noise block downconverter for use in a satellite broadcasting system receiver, said low noise block downconverter comprising:
a. a first low noise amplifier for providing an amplified k-band RF signal;
b. a local frequency oscillator for providing a local oscillator signal;
c. a high frequency diplexer for providing a diplexer output signal, said high frequency diplexer being electrically connected to said low noise amplifier, where said high frequency diplexer further comprises at least a first diplexer input for receiving said amplified k-band RF signal, a second diplexer input for receiving said local oscillator signal, and a diplexer output for providing a diplexer output signal substantially equal to the sum of the amplified RF signal and the local oscillator signal; and
d. a downconverter for receiving said diplexer output signal, wherein said downconverter provides an intermediate frequency output.

2. A low noise block downconverter according to claim 1 wherein said high frequency diplexer comprises a resistive summing junction.

3. A low noise block downconverter according to claim 1, wherein said high frequency diplexer comprises a distributed element frequency selective junction.

4. A low noise block downconverter according to claim 1, wherein said high frequency diplexer comprises a lumped element frequency selective junction.

5. A low noise block downconverter according to claim 1 wherein said downconverter comprises an integrated circuit chip.

6. A low noise block downconverter according to claim 5 wherein said integrated circuit chip comprises at least a first diode and a second diode, wherein said first diode and said second diode form an anti-parallel diode pair, said anti-parallel diode pair being electrically connected to high frequency diplexer.

7. A low noise block downcoverter according to claim 6 wherein said anti-parallel diode pair produces an intermediate frequency.

8. A low noise block downconverter according to claim 7 wherein said local oscillator signal is from about 9.75 GHz to about 11.3 GHz.

9. A low noise block downconverter according to claim 8, wherein said intermediate frequency is from about 950 MHz to about 2.15 GHz.

10. A low noise block downconverter according to claim 9 wherein said integrated circuit chip is configured in a sub-harmonically pumped arrangement.

11. A k-band mixer for use in a low noise block downconverter comprising:
a. a high frequency diplexer for providing a diplexer output signal, said high frequency diplexer having at least a first diplexer input for receiving a k-band RF signal, a second diplexer input for receiving a local oscillator signal,
b. a local frequency oscillator for providing said local oscillator signal to said second diplexer input; and
c. a downconverter configured to downconvert said diplexer output signal to provide an intermediate frequency output.

12. A k-band mixer according to claim 11 wherein said high frequency diplexer comprises a resistive summer.

13. A k-band mixer according to claim 14 wherein said high frequency diplexer comprises a lumped element selective junction.

14. A k-band mixer according to claim 13 wherein said high frequency diplexer comprises a distributed frequency selective junction.

15. A k-band mixer according to claim 14 wherein said downconverter comprises an integrated circuit chip, said integrated circuit chip having at least a first chip input, a second chip input and a chip output.

16. A k-band mixer according to claim 15 wherein said integrated chip further comprises at least a first diode and a second diode, wherein said first diode and said second diode form an anti-parallel diode pair, said anti-parallel diode pair being electrically connected to said diplexer.

17. A k-band frequency mixer according to claim 16 wherein said high frequency diplexer combines said k-band RF signal and said local oscillator signal to produce a combined high frequency signal, said combined high frequency signal being provided to said anti-parallel diode pair.

18. A k-band frequency mixer according to claim 17 wherein said anti-parallel diode pair produces an intermediate frequency.

19. A k-band frequency mixer according to claim 18 wherein said local oscillator signal is from about 9.75 GHz to about 11.3 GHz.

20. A k-band mixer according to claim 19, wherein said intermediate frequency is from about 950 MHz to about 2.15 GHz.

21. A k-band mixer according to claim 20, wherein said integrated circuit chip is configured in a sub-harmonically pumped arrangement.

22. A method for downconverting a k-band radio frequency, said method comprising:
combining a local oscillator frequency and a k-band RF frequency to produce a high frequency signal; and
inputting the high frequency signal into a downconverter to produce an intermediate frequency of from about 950 MHz to about 2.15 GHz, said downconverter comprising an integrated circuit chip containing an anti-parallel diode pair.

24. A method according to claim 23 wherein method further comprises the step of amplifying said intermediate frequency to a predetermined frequency.
